(19) United States
(12) Patent Application Publication
(10) Pub. No.: US 2024/0185005 A1
(43) Pub. Date: Jun. 6, 2024

(54) STANDARDIZED ASSET LOCATION TRACKING

(71) Applicant: The Boeing Company, Chicago, IL (US)

(72) Inventors: Parikshanth Ramesh, Bengaluru (IN); Jeetendra Verma, Maple Valley, WA (US); Sindhuja Sivadurai, Salem (IN); Brij Mohan Sharma, kanpur (IN); Sameeran Prashant Adgaonkar, Aurangabad (IN); Brian W. Pippen, Johns Island, SC (US); Elizabeth Killelea, Arlington Heights, IL (US)

(21) Appl. No.: 18/062,570

(22) Filed: Dec. 6, 2022

(51) Int. Cl. G06K 7/10; G06Q 10/0875

(52) U.S. Cl. CPC G06K 7/10128; G06Q 10/0875

(57) ABSTRACT

An information handling system (IHS), method and computer program product enables expeditious, scalable, and distributable asset location tracking in an enterprise using both passive radio frequency identification (RFID) technology and wireless communication to RFID tags. A controller of the IHS determines available source(s) of location data for a particular RFID tag from: (i) location data included in the RFID data; (ii) signal strength and direction data detected by a corresponding RFID sensor; and (iii) information indicating the zone sensed by the corresponding RFID sensor. The controller generates a standardized RFID event including a location defined in a standard spatial coordinate system in response to the one or more available sources of location data.

### TECHNICAL FIELD

The present disclosure relates generally to radio frequency identifier (RFID) tag detection, and more particularly to location tracking and reporting of passive and active RFID tag detection events for asset location management.

### BACKGROUND

Businesses rely upon asset tracking such as inventory parts, tools, and kits to control inventory costs and to ensure an ongoing ability to provide goods and services that use the tracked assets. Automating asset tracking can be necessary in supporting asset tracking within large enterprises with many assets whose locations are dynamically changed on a frequent basis. Conventional automated systems use passive radio frequency identification (RFID) tags that are attached to assets. An RFID reader or interrogator transmits an interrogation signal that activated the passive RFID tags and then receive a response from the passive RFID tags. With increasing implementation of industrial internet of things (IIoT), active RFID tags are being incorporated into industrial processes that are capable of wirelessly communicating using low power communication protocols such as ultrawide band (UWB) and Bluetooth low energy (BLE). Sensors configured for wireless communication are used to check the status of the IIoT active RFID tags.

Certain businesses, such as vehicle production, coordinate a large enterprise of inventory storage locations and factory workspaces to produce a product. Conventional asset tracking systems provide little applicability to these environments. The different types of sensors for passive RFID tags and IIoT active RFID tags have to be processed separately and queried by separate asset management systems. Attempts have been made to create a monolithic system that is capable of receiving RFID events, determining locations respectively of each RFID, and maintaining changes in location of particular assets. The result is a system that requires extensive customization for each location. The result also is a system that has such a large lag in tracking as to make the information not usable for a number of management functions.

### SUMMARY

In one aspect of the present disclosure, an information handling system (IHS) includes one or more radio frequency identification (RFID) sensors configured to be placed within a respective zone, for each zone, a RFID sensor configured to interrogate an RFID tag. The HIS system further includes a network interface communicatively connected over a network to an asset tracking system, and a memory that stores a location-based service (LBS) middleware application. The IHS system also includes a controller communicatively coupled to the RFID sensor, the network interface, and the memory. At least one hardware processor executes the LBS middleware application, causing the at least one hardware processor to perform the following operations: receiving one or more RFID events from the RFID sensor; for each of the one or more RFID events: determining the RFID for a corresponding particular RFID tag; determining one or more available sources of location data for the particular RFID tag selected from a group comprising: location data included in RFID data; signal strength and direction data detected by a corresponding RFID sensor; and information indicating a zone sensed by a corresponding RFID sensor; generates a standardized RFID event including the one or more available sources of location data; and based at least on the standardized RFID event, associating the RFID and the one or more available sources of location data with a tracked asset.

In another aspect of the present disclosure, a method includes a method including receiving, by a first RFID sensor of one or more RFID sensors, a first RFID event from a passive RFID tag in response to RFID interrogation in a first zone. The method includes receiving, by a second RFID sensor of the one or more RFID sensors, a second RFID event communicated within a second zone using a wireless communication protocol. For each RFID event, the method includes determining an RFID for a corresponding particular RFID tag of one of the passive RFID tag and the active RFID tag. The method includes determining one or more available sources of location data for the particular RFID tag selected from a group comprising: (i) location data included in the RFID data; (ii) signal strength and direction data detected by a corresponding RFID sensor; and (iii) information indicating the zone sensed by the corresponding RFID sensor. The method includes generating a standardized RFID event including the one or more available sources of location data. The method includes communicating the standardized RFID event, via the network interface, to the asset management system for associating the RFID and the one or more available sources of location data with a tracked asset.

In an additional aspect of the present disclosure, a computer readable storage media comprising computer-executable instructions that, when executed by a processor, cause the processor to perform the following operations: receiving, by a first RFID sensor of one or more RFID sensors, a first RFID event from a passive RFID tag in response to RFID interrogation in a first zone. The functionality includes receiving, by a second RFID sensor of the one or more RFID sensors, a second RFID event communicated within a second zone using a wireless communication protocol. For each RFID event, the functionality includes determining an RFID for a corresponding particular RFID tag of one of the passive RFID tag and the active RFID tag. The functionality includes determining one or more available sources of location data for the particular RFID tag selected from a group comprising: (i) location data included in the RFID data; (ii) signal strength and direction data detected by a corresponding RFID sensor; and (iii) information indicating the zone sensed by the corresponding RFID sensor. The functionality includes generating a standardized RFID event including the one or more available sources of location data. The functionality includes communicating the standardized RFID event, via the network interface, to the asset management system for associating the RFID and the one or more available sources of location data with a tracked asset.

These and other features are explained more fully in the embodiments illustrated below. It should be understood that in general the features of one embodiment also may be used in combination with features of another embodiment and that the embodiments are not intended to limit the scope of the invention.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 depicts a simplified functional block diagram of an information handling system (IHS) that generates standardized radio frequency identification (RFID) events from different RFID events received via RFID sensors from both passive and active RFID tags, according to one or more embodiments;

FIG. 2 depicts a simplified functional block diagram of an asset location management environment facilitated and managed by enterprise IHS 202 that is comprised of a multiple IHSes of FIG. 1, according to one or more embodiments;

FIG. 3 depicts a block diagram of deploying an industrial internet of location (I2L) platform in the enterprise IHS system of FIG. 2, including a development layer, to a cloud and edge deployments and integration with other systems and bedrock services, according to one or more embodiments;

FIG. 4 depicts functional block diagram of a fully deployed I2L platform in an example enterprise IHS system, according to one or more embodiments;

FIG. 5 presents a flow diagram of a method for expeditious, scalable, and distributable asset location tracking in an enterprise using both passive radio frequency identification (RFID) technology and wireless communication to active RFID tags, according to one or more embodiments; and

FIG. 6 presents a flow diagram of a method for using asset location tracking in a time critical scenario, according to one or more embodiments.

### DETAILED DESCRIPTION

According to aspects of the present disclosure, an information handling system (IHS), method and computer program product enable expeditious, scalable, and distributable asset location tracking in an enterprise using both passive radio frequency identification (RFID) technology and wireless communication to active RFID tags. A controller of the IHS determines available source(s) of location data for a particular RFID tag from: (i) location data included in the RFID data; (ii) signal strength and direction data detected by a corresponding RFID sensor; and (iii) information indicating the zone sensed by the corresponding RFID sensor. The controller generates a standardized RFID event including a location defined in a standard spatial coordinate system in response to the one or more available sources of location data. In a particular embodiment, the standard spatial coordinate system is world geodetic system (WGS) 84.

In one or more embodiments, the present disclosure provides location-based services (LBS) middleware that is designed to provide location tracking services to track assets (tools, kits, parts, personnel) primarily using RFID, ultrawide band (UWB), Bluetooth low energy (BLE), IEEE 802.11 wireless technology using passive or active tags. The LBS middleware integrates with information technology (IT) devices and provides a common data format, including latitude and longitude based on WGS 84. The standardized tag locate information is saved in a real-time data historian for use by other services like mobile operations management (MOM) and enterprise resource planning (ERP). The LBS middle may be implemented as an edge and cloud based deployment, where the device communication and data processing happen on the edge and the other control services like device, location, user interface (UI) and other interface services run at the cloud layer. The LBS middleware may be light, just processing tag read events, which enables handling potentially billions of tag read events per week in a large enterprise.

Aspects of the disclosure provide solutions for location tracking services to track assets. Aspects of the disclosure have a technical effect of improved operation of a computing, for example by reducing lag in tracking, improving the efficiency of computational hardware, and provide better allocation of resources, as compared to traditional systems. For example, aspects herein improve the operation of a computer by reducing the computation time (e.g., speed improvement). For example, aspects of the disclosure enable the use of a standard format, such as WGS 84, to locate assets without having to convert location to suit particular locations/maps. Further, aspects of the disclosure reduce or eliminate a need to require extensive customization for each location.

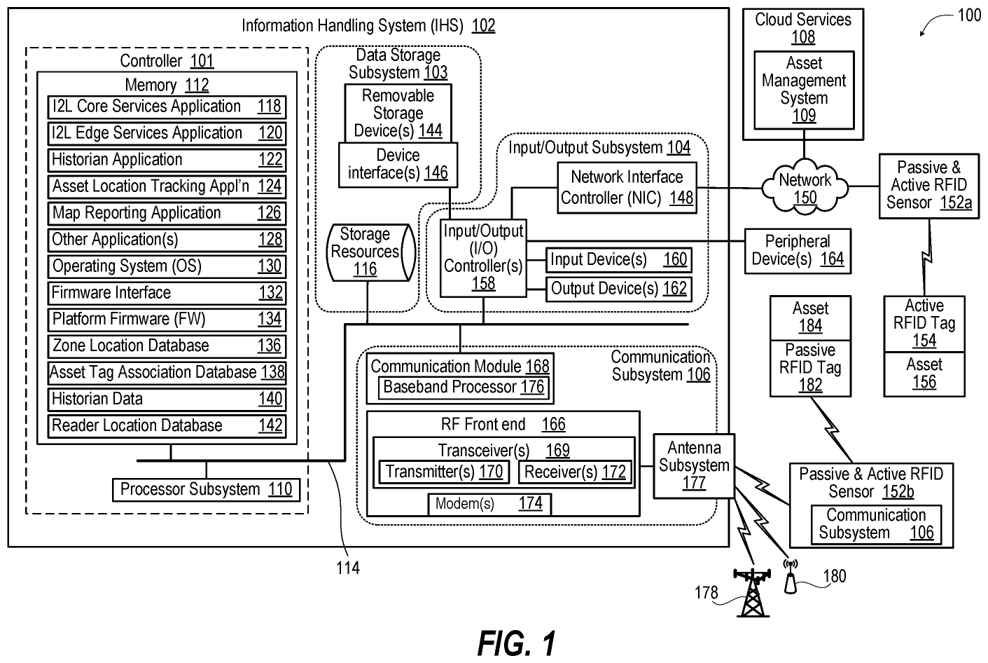

Turning to the Drawings, FIG. 1 depicts a functional block diagram of enterprise IHS environment 100 that includes IHS 102 managed by controller 101, that performs at least a portion of location-based tracking by configuring data storage subsystem 103, input/output subsystem 104 and communication subsystem 106. Cloud services 108 of enterprise IHS environment 100 provides asset management system 109 for backend processing and distribution of location-based services. Within the general context of IHSs, IHS 102 may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, IHS 102 may be a server, blade server, rack-mounted server, rack-mounted data storage, or other rack-mounted IT equipment in a data center. IHS 102 may include random access memory (RAM), one or more processing resources such as a central processing unit (CPU) or hardware or software control logic, read only memory (ROM), and/or other types of nonvolatile memory. Additional components of the IHS 102 may include one or more disk drives, one or more network ports for communicating with external devices as well as various input and output (I/O) devices, such as a keyboard, a mouse, and a video display. The IHS 102 may also include one or more buses operable to transmit communications between the various hardware components.

Controller 101 includes processor subsystem 110 communicatively coupled to memory 112. Processor subsystem 110 is coupled to memory 112 via system interconnect 114. System interconnect 114 can be interchangeably referred to as a system bus, in one or more embodiments. System interconnect 114 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus. For the purpose of this disclosure, system interconnect 114 can also be a Double Data Rate (DDR) memory interface. Memory 112 can either be contained on separate, removable dual inline memory module (RDIMM) devices or memory 112 can be contained within persistent memory devices (NVDIMMs). For example, the NVDIMM-N variety of NVDIMMs contain both random access memory, which can serve as memory 112, and non-volatile memory. It should be noted that other channels of communication can be contained within system interconnect 114, including but not limited to inter-integrated circuit (i2c) or system management bus (SMBus). System interconnect 114 communicatively couples various system components. Examples of system components include local storage resources 116 of data storage subsystem 103 that are replaceable such as solid state drives (SDDs) and hard disk drives (HDDs). Software and/or firmware modules and one or more sets of data that can be stored on local storage resources 116 and be utilized during operations of IHS 102. Specifically, in one embodiment, memory 112 can include therein a plurality of such modules, including industrial internet for location (I2L) core services application 118, I2L edge services application 120, historian application 122, asset location tracking application 124, map reporting application 126, and other application(s) 128. Memory 112 can also store operating system (OS) 130, firmware interface 132 such as basic input/output system (BIOS) or Uniform Extensible Firmware Interface (UEFI), and platform firmware (FW) 134. These software and/or firmware modules have varying functionality when their corresponding program code is executed by processor subsystem 110 or secondary processing devices within IHS 102. Memory 112 can include computer data structures and data values such as zone location database 136, asset tag association database 138, historian data 140, and reader location database 142 used by applications (118, 120, 122, 124, 126, 128).

Data storage subsystem 103 of IHS 102 includes local storage resources 116. Controller 101 is communicatively connected, via system interlink 114, to local storage resources 116. Data storage subsystem 103 provides applications, program code, such as computer-executable instructions on computer-readable media that is accessible by controller 101. For example, data storage subsystem 103 can provide a selection of applications and computer data such as I2L edge services application 120 and other application(s) 128 that use asset location tracking services. These applications can be loaded into device memory 112 for execution by controller 101. In one or more embodiments, local storage resources 116 can include hard disk drives (HDDs), optical disk drives, and/or solid-state drives (SSDs), etc. Data storage subsystem 103 can include removable storage device(s) (RSD(s)) 144, which is received in RSD interface 146. Controller 101 is communicatively connected to RSD 144, via system interlink 114 and RSD interface 146. In one or more embodiments, RSD 144 is a non-transitory, physical computer program product or computer readable storage device. Controller 101 can access data storage device(s) 116 or RSD 144 to provision communication device 100 with program code, such as code for one or more of video conference application 114 and other application(s) 116.

Computer storage media include volatile and non-volatile, removable and non-removable, media implemented in any method or technology for storage of information such as computer readable instructions, data structures, program modules or the like. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing apparatus. Computer storage media are tangible, non-transitory, and mutually exclusive to communication media. In contrast to computer storage media, communication media embody computer readable instructions, data structures, program modules, and/or the like in a modulated data signal, such as a carrier wave and/or other transport mechanism. Therefore, a computer storage medium should not be interpreted to be a propagating signal per se. Propagated signals per se are not examples of computer storage media.

Input/Output subsystem 104 includes a network interface, depicted as network interface controller (NIC) 148. NIC 126 is communicatively connected via a network 150 to other IHSes and remote devices within enterprise IHS 100 such as cloud services 108. NIC 148 enables IHS 102 and/or components within IHS 102 to communicate and/or interface with other devices, services, and components that are located external to IHS 102. In an example, passive and active RFID sensor 152a is communicatively coupled to network 150 and is within sensing range of active RFID tag 154 attached to asset 156. Examples of asset 156 include an inventory part, a tool, a person, etc. These devices, services, and components can interface with IHS 102 via an external network, such as network 150, using one or more communication protocols that include transport control protocol (TCP/IP) and network block device (NBD) protocol. Network 150 can be a local area network, wide area network, personal area network, and the like, and the connection to and/or between network 150 and IHS 102 can be wired, wireless, or a combination thereof. For purposes of discussion, network 150 is indicated as a single collective component for simplicity. However, it should be appreciated that network 150 can comprise one or more direct connections to other devices as well as a more complex set of interconnections as can exist within a local area network or a wide area network, such as the Internet.

Input/Output subsystem 104 further includes one or more input/output (I/O) controllers 158 that support connection by and processing of signals from one or more connected input device(s) 160, such as a keyboard, mouse, touch screen, or microphone. I/O controllers 158 also support connection to and forwarding of output signals to one or more connected output device(s) 162, such as a monitor or display device or audio speaker(s). I/O controllers 158 can provide a communication interface to peripheral devices 164. In one or more embodiments, IHS 102 operates autonomously without direct user interfaces provided by input and output devices 160 and 162. Additionally, in one or more embodiments, one or more device interfaces 154, such as an optical reader, a universal serial bus (USB), a card reader, Personal Computer Memory Card International Association (PCMCIA) slot, and/or a high-definition multimedia interface (HDMI), can be associated with IHS 102. RSD interface(s) 146 can be utilized to enable data to be read from or stored to corresponding removable storage device(s) 144, such as a compact disk (CD), digital video disk (DVD), flash drive, or flash memory card. In one or more embodiments, device interface(s) 154 can further include general purpose I/O interfaces such as inter-integrated circuit (I²C), system management bus (SMB), and peripheral component interconnect (PCI) buses.

Communication subsystem 106 of communication device 100 enables over-the-air (OTA) communication with external communication systems. Communication subsystem 106 includes radio frequency (RF) frontend 166 and communication module 168. RF frontend 166 includes transceiver(s) 169, which includes transmitter(s) 170 and receiver(s) 172. RF frontend 166 further includes modem(s) 174. Communication module 168 of communication subsystem 106 includes baseband processor 176. Baseband processor 176 communicates with controller 101 and RF frontend 166. Baseband processor 176 operates in baseband frequency range to encode data for transmission and decode received data, according to a communication protocol. Modem(s) 174 modulate baseband encoded data from communication module 168 onto a carrier signal to provide a transmit signal that is amplified by transmitter(s) 170. Modem(s) 174 demodulates each signal received from external communication system detected by antenna subsystem 177. The received signal is amplified and filtered by receiver(s) 172, which demodulate received encoded data from a received carrier signal.

In one or more embodiments, controller 101, via communication subsystem 106, performs multiple types of over-the-air (OTA) or wireless communication using one or more IEEE 802.11 wireless local area network (WLAN), an OTA ad hoc network, personal access network (PAN), wireless industrial fieldbus networks, etc. Examples of PAN include such as Bluetooth low energy (BLE) and ultrawide band (UWB). Communication subsystem 106 can also support wireless connection to base node 178 for connecting to a cellular carrier or access node 180 for connecting to a wireless wide area network (WWAN). Controller 100, via communication subsystem 106, communicatively connects to passive and active RFID sensor 152b, which also has communication sensor 106, either directly via an ad hoc network of PAN or via one of base node 178 and access node 180. passive and active RFID sensor 152b relays RFID events such as from passive RFID tag 182 that is attached to asset 184. In one or more embodiments, communication subsystem 106 of IHS 102 can function as passive and active RFID sensor 152b.

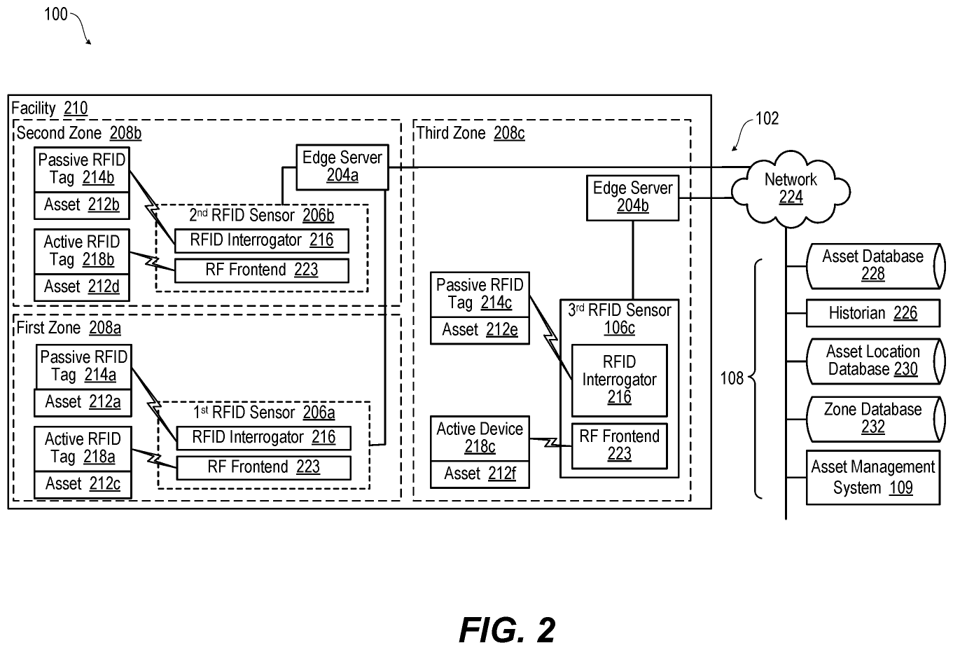

FIG. 2 depicts a simplified functional block diagram of an asset location management environment 200 facilitated and managed by enterprise IHS 100 that is comprised of a multiple IHSes 102 of FIG. 1. In an example, one or more edge servers 204a-204b are implementations respectively of IHS 102 (FIG. 1) and can have identical or similar components. Cloud services 108 is similarly implemented by a number of IHS 102 (FIG. 1) and configured to operate as network components in data centers and similar configurations. Edge servers 204a-204b communicate with one or more RFID sensors 206a-206c that may be at a fixed or mobile location within respective zones 208a-208c in facility 210. For clarity, three zones 208a, 208b, and 208c are depicted with first zone 208a below second zone 208b and third zone 208c laterally offset from both first and second zones 208a-208b. Edge server 204a supports both RFID sensors 206a-206b respectively in first and second zones 208a-208b. Second edge server 204b supports third RFID sensor 206c in third zone 208c. Third RFID sensor 206c includes integral RFID interrogator 216 that detects passive RFID tag 214c on asset 212e and. RF frontend 223 that detects active RFID tag 218c on asset 212f.

IHS 202 supports location-based tracking for different types of over-the-air reporting technologies. In one or more embodiments, assets 212a-212b having respective passive RFID tags 214a-214b. RFID sensors 206a-206b each include respective RFID interrogator 216 that can read passive RFID tags 214a-214b. In one or more embodiments, assets 212c-212d include active RFID tags 218a-218b that are configured to wirelessly communicate identification information. In an example, active RFID tags 218a-218b are an attached tag having stored power sufficient to support communication in a low power communication protocol such as ultrawide band (UWB) or Bluetooth low energy (BLE). In another example, active RFID tags 218a-218b are integral components or functions of assets 212c-212d. For example, assets 212c-212d are IIoT industrial sensors that provide a sensed measurement via wireless communication by respective active RFID tags 218a-218b to wireless fieldbus 220 monitored by industrial controller 222. RFID sensors 206a-206b each include respective RF frontend 223 that can interface to wireless fieldbus 220 or directly to active RFID tags 218a-218b to receive RFID events via wireless communication.

In an example, RFID sensors 206a-206b detect a signal direction in a horizontal X-Y plane. Z-axis vertical direction is only identified as being within a reception range of respective RFID sensors 206a-206b, such as respectively first and second zones 208a-208b. In another example, third RFID sensor 206c has vertical direction sensing in the Z-axis to identify a more granular location of a received signal in third zone 208c. Distance from respective RFID sensors 206a-206c may be determined based on peak received signal strength indicator (RSSI). In an additional embodiment, RFID sensors 206a-206c may determine location of a particular RFID tag that is self-reported.

Controllers 101 (FIG. 1) of edge servers 204a-204b receive two or more data formats of RFID events from passive RFID tags 214a-214b and active RFID tags 218a-218b. In one or more embodiments, controllers 101 (FIG. 1) convert each RFID event into a common, standardized RFID event such as the following:

| | | |
|---|---|---|
| ● | { | |
| ● | ″epcCode″: “Tag-12”, | <<Tag Id>> |
| ● | ″peakRSSI″: −90.0, | <<Passive read strength>> |
| ● | ″firstSeenTimestamp″: 1600682630709000, | <<Time stamp>> |
| ● | ″hostName″: ″Reader-4″, | <<Reader name>> |
| ● | ″antennaPort″: 1, | <<Reader antenna port>> |
| ● | ″x″: 0.0, | <<active reader positions>> |
| ● | ″y″: 0.0, | <<active reader positions>> |
| ● | ″z″: 0.0, | <<active reader positions>> |
| ● | ″location″: { | <<location mapped to the |

reader>>

| | |
|---|---|
| ● | ″id″: ″Zone-1″, |
| ● | ″site″: ″Zone-1-site″, |
| ● | ″building″: ″Zone-1-building″, |
| ● | ″floor″: ″ 1″, |
| ● | ″name″: ″Zone-1″ |
| ● | } |
| ● | } |

Edge servers 204a-204b communicate the standardized RFID events via network 224 to cloud services 108. In one or more embodiments, asset management system 109, which is part of cloud services 108, maintains and uses information to associate the RFID events with assets and location. In an example, asset management system 109 accesses current RFID events in historian 226 and accesses the associated information in

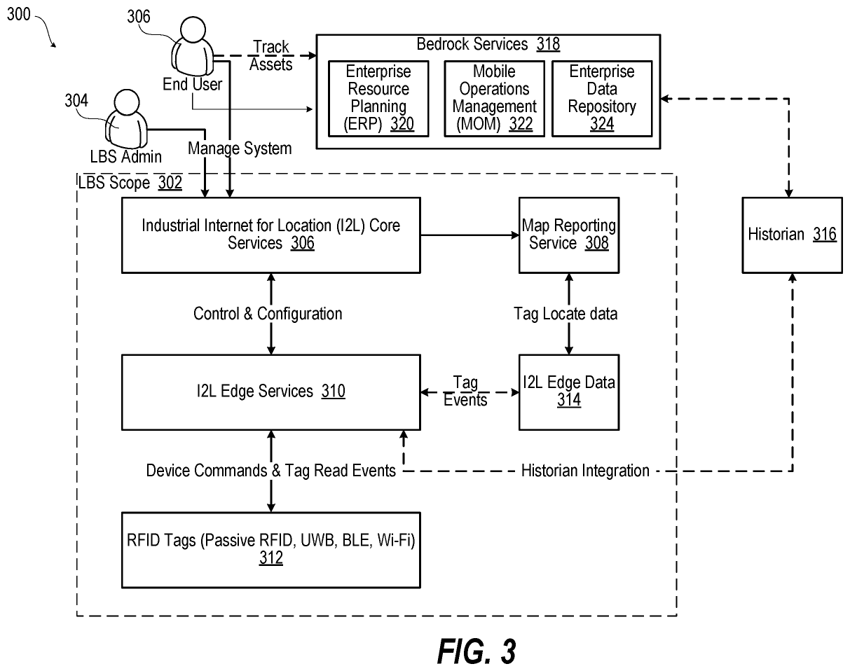

FIG. 3 depicts a block diagram of industrial internet of location (I2L) platform 300 in enterprise IHS 100 of FIG. 2, deployed from a development layer to a cloud and edge deployments and integration with other systems and bedrock services. LBS scope 302 is managed by LBS administrator 304 and end user 306 via I2L core services 306 that is integrated with map reporting service 308. I2L core services 306 exchanges control and configuration settings with I2L edge services 310 that provide device commands and receive tag read events from RFID from devices such as RFID tags 312 via passive RFID interrogation, UWB communication, BLE communication or 802.11 wireless communication. An example of 802.11 wireless communication is Wi-Fi™ communication. I2L edge services 310 I2L processes tag events to become standardized edge data 314 that is further analyzed to refine tag locate data for map reporting service 308. Historian 316 is integrated with LBS scope 302 to maintain current standardized edge data 314. Bedrock services 318 is a consumer of standardized edge data 314 from historian 316. Bedrock services 318 includes enterprise resource planning 320, mobile operations management (MOM) 322, and enterprise data repository 324. End user 306 tracks assets via bedrock services 318.

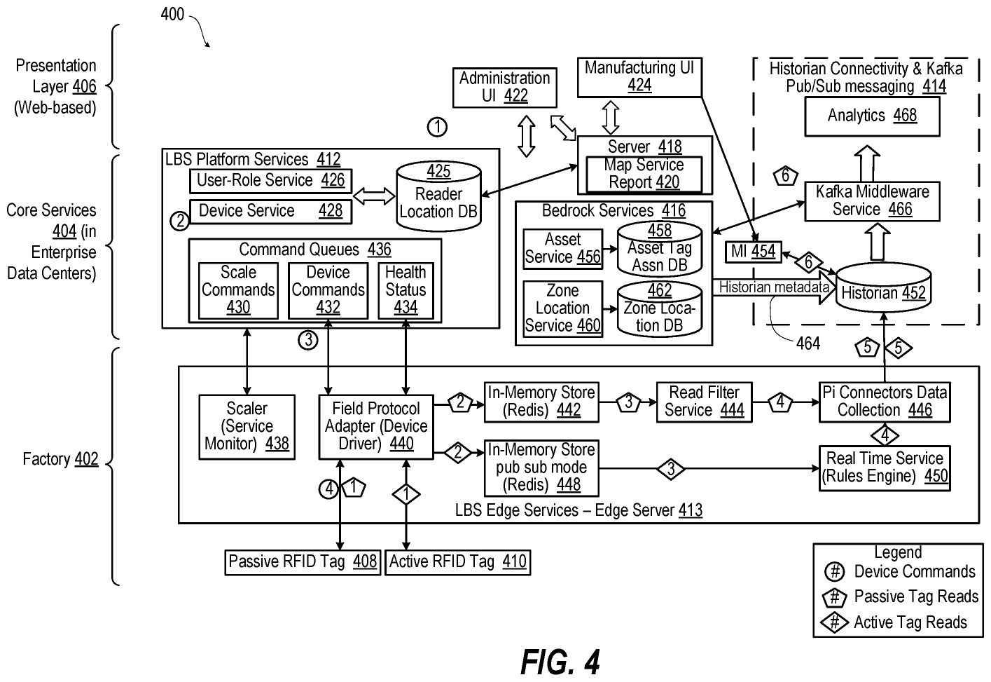

FIG. 4 depicts functional block diagram of a fully deployed I2L platform in example enterprise IHS system 400 distributed across factory layer 402, core services layer 404 implemented in enterprise data centers, and a presentation layer 406 that is web-based. Passive RFID tags 408 and active RFID tags 410 are stored in or pass through factory layer 402. At factory level 402, edge servers 410 provide LBS edge services in part by reading RFID events from passive RFID tags 408 and active RFID tags 410. At core services layer 404, LBS platform services 412 provide commands to edge servers 413 at factory level 402. Historian connectivity and Kafka pub/sub messaging system 414 at core services layer 404 receives RFID event data from edge servers 413 of factory level 402 and interacts with bedrock services 416 of core services layer 404. Server(s) 418 at core services layer 404 support map report service 420 that provides information to administration user interface (UI) 422 and manufacturing UI 424 of presentation layer 406. LBS platform services 412 includes reader location database 425 to map report service 420.

In an example, administration UI 422 provides a web single sign-on (WSSO) via WordPress OAuth 2.0 Client as device command #1 that is relayed to user-role service 426 and device service 428 of LBS platform services 412. Device command #2 in advanced messaging queuing protocol (AMQP) from device service 428 generates scale commands 430, device commands 432, and health status 434 in communication queues 436 as device commands #3. Edge servers 410 in factory layer 402 provide LBS edge services that include scaler 438, such as by a service monitor that receives scale commands 430 and field protocol adapter 440 such as by a device driver that enables communication with passive RFID tags 408 and active RFID tags 410 as device commands #4. Passive RFID tags 408 respond with passive tag reads #1 and active RFID tags 410 respond with active tag reads #1 to field protocol adapter 440. Field protocol adapter 440 communicates passive RFID tag reads #3 to in-memory store 442, such as provided by Redix and then through read filter service 444 to throttle and remove duplicates before being passed as passive RFID tag reads #4 to Pi connectors data collection 446. Field protocol adapter 440 communicates active RFID tag reads #3 to in-memory store pub sub mode 448, such as provided by Redix that is passed to real time service 450 that performs a rule engine before passing as active RFID tag read #4 to Pi connectors data collection 446. Pi connectors data collection 446 passes passive and active RFID tag reads #5 to historian 452 of historian connectivity and Kafka pub/sub messaging system 414. Historian can be a tradeoff between a local historian versus an enterprise historian or a local web socket client. Manufacturing information (MI) 454 from manufacturing UI 424 as active RFID tag reading #6 in real-time PI AF SDK to historian 452. PI AF SDK is the foundational.NET-based software development kit for interacting with asset metadata and time series data stored in the PI Asset Framework. Bedrock services 416 includes asset service 456 that manages asset tag association database 458 and zone location service 460 that manages zone location database 462 and provides historian metadata 464 to historian 452. Historian can be configured to use the same instance of asset metadata as in bedrock services 416. Historian 452 passes near real time data to Apache Kafka middleware service 466, which is an event driven streaming platform of historian connectivity and Kafka pub/sub messaging system 414. Passive RFID tag read #6 passes between Kafka pub/sub messaging system 414 and bedrock services 416. Kafka middleware service 466 passes near real time Kafka publications to other bedrock services and enterprise manufacturing analytics 468,

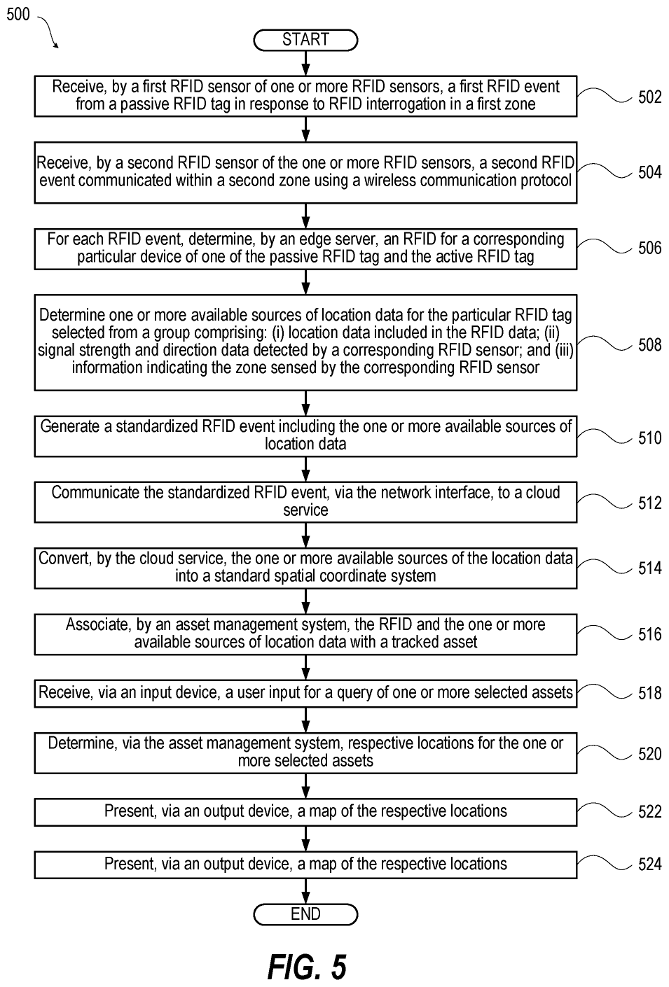

FIG. 5 presents a flow diagram of method 500 for expeditious, scalable, and distributable asset location tracking in an enterprise using both passive RFID technology and wireless communication to active RFID tags. In one or more embodiments, controller 101 configures IHS 102 (FIG. 1) to perform the functionality of method 500. Components described with regard to FIGS. 1-4 and referenced in method 500 can be identical or similar. Method 500 includes receiving, by a first RFID sensor of one or more RFID sensors, a first RFID event from a passive RFID tag in response to RFID interrogation in a first zone (block 502). Method 500 includes receiving, by a second RFID sensor of the one or more RFID sensors, a second RFID event communicated within a second zone using a wireless communication protocol (block 504). In an example, the first RFID sensor and the second RFID sensor may be integrated in one device. The first zone may be the same as the second zone. The wireless communication protocol(s) may be at least one of IEEE 802.11 wireless, ultrawide band (UWB) and Bluetooth low energy (BLE). Method 500 includes, for each RFID event, determining, by an edge server, an RFID for a corresponding particular device of one of the passive RFID tag and the active RFID tag (block 506). In an example, the edge server parses a lightweight computer data interchange format such as Json, short for JavaScript Object Notation, for substrings that correspond to the RFID, the location of the particular device; and identifier for a corresponding RFID sensor. Method 500 includes determining one or more available sources of location data for the particular device selected from a group comprising: (i) location data included in the RFID data; (ii) signal strength and direction data detected by a corresponding RFID sensor; and (iii) information indicating the zone sensed by the corresponding RFID sensor (block 508). Method 500 includes generating a standardized RFID event including the one or more available sources of location data (block 510). Method 500 includes communicating the standardized RFID event, via the network interface, to a cloud service (block 512). Method 500 includes converting, by the cloud service, the one or more available sources of the location data into a standard spatial coordinate system (block 514). In one or more embodiments, the standard spatial coordinate system is world geodetic system (WGS) 84. Method 500 includes associating, by an asset management system, the RFID and the one or more available sources of location data with a tracked asset (block 516). Method includes receiving, via an input device, a user input for a query of one or more selected assets (block 518). Method 500 includes determining, via the asset management system, respective locations for the one or more selected assets (block 520). Method 500 includes presenting, via an output device, a map of the respective locations (block 522). Then method 500 ends.

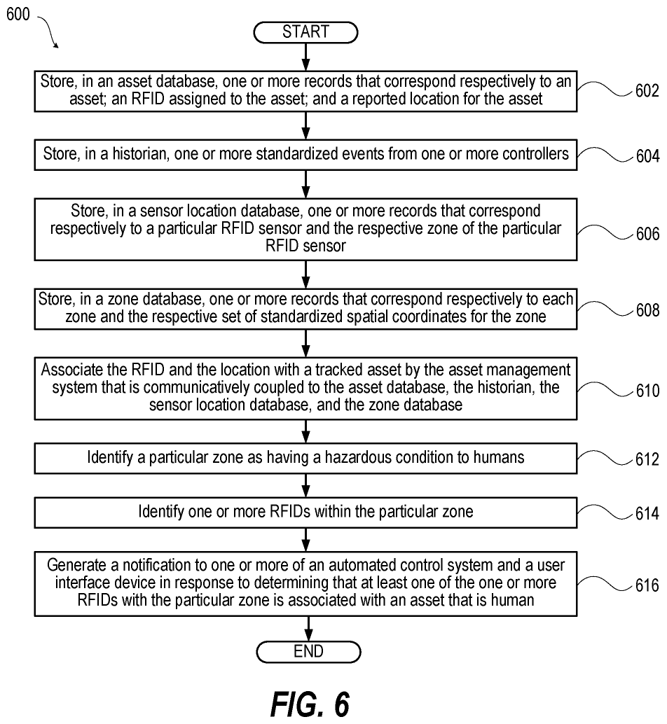

FIG. 6 presents a flow diagram of method 600 for using asset location tracking in a time critical scenario. In one or more embodiments, controller 101 configures IHS 102 (FIG. 1) to perform the functionality of method 600. Components described with regard to FIGS. 1-5 and referenced in method 600 can be identical or similar. Method 600 includes storing, in an asset database, one or more records that correspond respectively to an asset; an RFID assigned to the asset; and a reported location for the asset (block 602). Method 600 includes storing, in a historian, one or more standardized events from one or more controllers (block 604). Method 600 includes storing, in a sensor location database, one or more records that correspond respectively to a particular RFID sensor and the respective zone of the particular RFID sensor (block 606). Method 600 includes storing, in a zone database, one or more records that correspond respectively to each zone and the respective set of standardized spatial coordinates for the zone (block 608). Method 600 includes associating the RFID and the location with a tracked asset by the asset management system that is communicatively coupled to the asset database, the historian, the sensor location database, and the zone database (block 610). Method 600 includes identifying a particular zone as having a hazardous condition to humans (block 612). Method 600 includes identifying one or more RFIDs within the particular zone (block 614). Method 600 includes generating a notification to one or more of an automated control system and a user interface device in response to determining that at least one of the one or more RFIDs with the particular zone is associated with an asset that is human (block 616). Then method 600 ends.

Although described in connection with the IHS 102, implementations of the disclosure are capable of implementation with numerous other general-purpose or special-purpose computing system environments, configurations, or devices. Implementations of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, VR devices, holographic device, and the like. Such systems or devices accept input from the user in any way, including from input devices such as a keyboard or pointing device, via gesture input, proximity input (such as by hovering), and/or via voice input.

Implementations of the disclosure are described in the general context of computer-executable instructions, such as program modules, executed by one or more computers or other devices in software, firmware, hardware, or a combination thereof. In one implementation, the computer-executable instructions are organized into one or more computer-executable components or modules. Generally, program modules include, but are not limited to, routines, programs, objects, components, and data structures that perform particular tasks or implement particular abstract data types. In one implementation, implementations of the disclosure are implemented with any number and organization of such components or modules. For example, implementations of the disclosure are not limited to the specific computer-executable instructions or the specific components or modules illustrated in the figures and described herein. Other implementations of the disclosure include different computer-executable instructions or components having more or less functionality than illustrated and described herein. In implementations involving a general-purpose computer, implementations of the disclosure transform the general-purpose computer into a special-purpose computing device when configured to execute the instructions described herein.

By way of example and not limitation, computer readable media comprise computer storage media and communication media. Computer storage media include volatile and nonvolatile, removable, and non-removable memory implemented in any method or technology for storage of information such as computer readable instructions, data structures, program modules, or the like. Computer storage media are tangible, non-transitory, and mutually exclusive to communication media. Computer storage media are implemented in hardware and exclude carrier waves and propagated signals. Computer storage media for purposes of this disclosure are not signals per se. In one implementation, computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium used to store information for access by a computing device. In contrast, communication media typically embody computer readable instructions, data structures, program modules, or the like in a modulated data signal such as a carrier wave or other transport mechanism and include any information delivery media.

The examples disclosed herein are described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples are practiced in a variety of system configurations, including personal computers, laptops, smart phones, mobile tablets, hand-held devices, consumer electronics, specialty computing devices, etc. The disclosed examples are also practiced in distributed computing environments, where tasks are performed by remote-processing devices that are linked through a communications network.

An example information handling system (IHS) comprises: one or more radio frequency identification (RFID) sensors configured to be placed within a respective zone, for each zone, a RFID sensor configured to interrogate an RFID tag and; a network interface communicatively connected over a network to an asset tracking system; a memory that stores a location-based service (LBS) middleware application; a controller communicatively coupled to the RFID sensor, the network interface, and the memory; at least one hardware processor that executes the LBS middleware application, causing the at least one hardware processor to perform the following operations: receiving one or more RFID events from the RFID sensor; for each of the one or more RFID events: determining the RFID for a corresponding particular RFID tag; determining one or more available sources of location data for the particular RFID tag selected from a group comprising: location data included in RFID data; signal strength and direction data detected by a corresponding RFID sensor; and information indicating a zone sensed by a corresponding RFID sensor; generates a standardized RFID event including the one or more available sources of location data; and based at least on the standardized RFID event, associating the RFID and the one or more available sources of location data with a tracked asset.

An example method comprises: receiving, by a first radio frequency (RF) location sensor of one or more RFID sensors, a first radio frequency identification (RFID) event from an RFID tag in response to RFID interrogation in a first zone; receiving, by a second RFID sensor of the one or more RFID sensors, a second RFID event communicated within a second zone using a wireless communication protocol; for each RFID event, determining an RFID for a corresponding particular RFID tag of one of a passive RFID tag and an active RFID tag; determining one or more available sources of location data for the particular RFID tag selected from a group comprising: location data included in the RFID data; signal strength and direction data detected by a corresponding RFID sensor; and information indicating a zone sensed by a corresponding RFID sensor; generating a standardized RFID event including the one or more available sources of location data; and based at least on the standardized RFID event, associating the RFID and the one or more available sources of location data with a tracked asset.

An example Computer readable storage media comprising computer-executable instructions that, when executed by a processor, cause the processor to perform the following operations: receiving, by a first radio frequency (RF) location sensor of one or more RFID sensors, a first radio frequency identification (RFID) event from an RFID tag in response to RFID interrogation in a first zone; receiving, by a second RFID sensor of the one or more RFID sensors, a second RFID event communicated within a second zone using a wireless communication protocol; for each RFID event, determining an RFID for a corresponding particular RFID tag of one of a passive RFID tag and an active RFID tag; determining one or more available sources of location data for the particular RFID tag selected from a group comprising: location data included in the RFID data; signal strength and direction data detected by a corresponding RFID sensor; and information indicating a zone sensed by a corresponding RFID sensor; generating a standardized RFID event including the one or more available sources of location data; and based at least on the standardized RFID event associating the RFID and the one or more available sources of location data with a tracked asset.

Alternatively, or in addition to the other examples described herein, examples include any combination of the following:
the RFID is a passive RFID tag, and the IHS further comprises a second RFID sensor configured to wirelessly communicate with an active RFID tag that communicate using a wireless communication protocol, each RFID sensor comprising: one or more RF antennas configured to receive RF signals within a respective zone; and an RF frontend configured, via the one or more RF antennas, to perform one or more of the following: interrogate the passive RFID tags for RFID data, to wirelessly communicate with the active RFID tags to receive RFID data during an RFID event, and to relay the RFID data from the RFID event;
an edge server that generates the standardized RFID event;
a cloud service communicatively coupled to the edge server, the cloud service configured to: receive the standardized RFID event from the edge server; and convert the one or more available sources of the location data into a standard spatial coordinate system in response to the one or more available sources of location data;
the standard spatial coordinate system comprises world geodetic system (WGS) 84;
the RFID sensor and the second RFID sensor are provided by one device;
the wireless communication protocol comprises at least one of ultrawide band (UWB) and Bluetooth low energy (BLE);
the controller parses the RFID event comprising a lightweight computer data interchange format for substrings that correspond to the RFID, the location of the particular RFID tag, and identifier for a corresponding RFID sensor;
an asset database that stores one or more records that correspond respectively to an asset;
an RFID assigned to the asset, and a reported location for the asset;
a historian that stores and distributes one or more standardized events from one or more controllers;
a sensor location database that stores one or more records that correspond respectively to a particular RFID sensor and the respective zone of the particular RFID sensor;
a zone database that stores one or more records that correspond respectively to each zone and the respective set of standardized spatial coordinates for the zone; and
an asset management system that is communicatively coupled to the asset database, the historian, the sensor location database, and the zone database for associating the RFID and the location with the tracked asset;
the asset management system: identifies a particular zone as having a hazardous condition to humans; identifies one or more RFIDs within the particular zone; and generates a notification to one or more of an automated control system and a user interface device in response to determining that at least one RFID within the particular zone is associated with an asset that is human;
a map report service;
a user interface device having an input device and an output device and communicatively coupled to the asset management system and the map report service and which: receives, via the input device, a user input for a query of one or more selected assets; determines, via the asset management system, respective locations for the one or more selected assets; and presents, via the output device, a map of the respective locations.

When introducing elements of aspects of the disclosure or the implementations thereof, the articles “a,” “an,” “the,” and “said” are intended to mean that there are one or more of the elements. The terms “comprising,” “including,” and “having” are intended to be inclusive and mean that there could be additional elements other than the listed elements. The term “implementation” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. An information handling system (IHS) comprising:
one or more radio frequency identification (RFID) sensors configured to be placed within a respective zone, for each zone, a RFID sensor configured to interrogate an RFID tag and;
a network interface communicatively connected over a network to an asset tracking system;
a memory that stores a location-based service (LBS) middleware application;
a controller communicatively coupled to the RFID sensor, the network interface, and the memory;
at least one hardware processor that executes the LBS middleware application, causing the at least one hardware processor to perform the following operations:
receiving one or more RFID events from the RFID sensor;
for each of the one or more RFID events:
determining the RFID for a corresponding particular RFID tag;
determining one or more available sources of location data for the particular RFID tag selected from a group comprising: location data included in RFID data; signal strength and direction data detected by a corresponding RFID sensor; and information indicating a zone sensed by a corresponding RFID sensor;
generates a standardized RFID event including the one or more available sources of location data; and
based at least on the standardized RFID event, associating the RFID and the one or more available sources of location data with a tracked asset.

2. The IHS of claim 1, wherein the RFID is a passive RFID tag, and wherein the IHS further comprises a second RFID sensor configured to wirelessly communicate with an active RFID tag that communicate using a wireless communication protocol, each RFID sensor comprising:
one or more RF antennas configured to receive RF signals within a respective zone; and
an RF frontend configured, via the one or more RF antennas, to perform one or more of the following: interrogate the passive RFID tags for RFID data, to wirelessly communicate with the active RFID tags to receive RFID data during an RFID event, and to relay the RFID data from the RFID event.

3. The IHS of claim 2, further comprising:
an edge server that generates the standardized RFID event; and
a cloud service communicatively coupled to the edge server, the cloud service configured to:
receive the standardized RFID event from the edge server; and
convert the one or more available sources of the location data into a standard spatial coordinate system in response to the one or more available sources of location data.

4. The IHS of claim 3, wherein:
the standard spatial coordinate system comprises world geodetic system (WGS) 84;
the RFID sensor and the second RFID sensor are provided by one device; and
the wireless communication protocol comprises at least one of ultrawide band (UWB) and Bluetooth low energy (BLE).

5. The IHS of claim 1, wherein the controller parses the RFID event comprising a lightweight computer data interchange format for substrings that correspond to the RFID, the location of the particular RFID tag, and identifier for a corresponding RFID sensor.

6. The IHS of claim 1, further comprising:
an asset database that stores one or more records that correspond respectively to an asset, an RFID assigned to the asset, and a reported location for the asset;
a historian that stores and distributes one or more standardized events from one or more controllers;
a sensor location database that stores one or more records that correspond respectively to a particular RFID sensor and the respective zone of the particular RFID sensor;
a zone database that stores one or more records that correspond respectively to each zone and the respective set of standardized spatial coordinates for the zone; and
an asset management system that is communicatively coupled to the asset database, the historian, the sensor location database, and the zone database for associating the RFID and the location with the tracked asset.

7. The IHS of claim 6, wherein the asset management system:
identifies a particular zone as having a hazardous condition to humans;
identifies one or more RFIDs within the particular zone; and
generates a notification to one or more of an automated control system and a user interface device in response to determining that at least one RFID within the particular zone is associated with an asset that is human.

8. The IHS of claim 6, further comprising:
a map report service;
a user interface device having an input device and an output device and communicatively coupled to the asset management system and the map report service and which:
receives, via the input device, a user input for a query of one or more selected assets;
determines, via the asset management system, respective locations for the one or more selected assets; and
presents, via the output device, a map of the respective locations.

9. A method comprising:
receiving, by a first radio frequency (RF) location sensor of one or more RFID sensors, a first radio frequency identification (RFID) event from an RFID tag in response to RFID interrogation in a first zone;
receiving, by a second RFID sensor of the one or more RFID sensors, a second RFID event communicated within a second zone using a wireless communication protocol;
for each RFID event, determining an RFID for a corresponding particular RFID tag of one of a passive RFID tag and an active RFID tag;
determining one or more available sources of location data for the particular RFID tag selected from a group comprising: location data included in the RFID data; signal strength and direction data detected by a corresponding RFID sensor; and information indicating a zone sensed by a corresponding RFID sensor;
generating a standardized RFID event including the one or more available sources of location data; and
based at least on the standardized RFID event, associating the RFID and the one or more available sources of location data with a tracked asset.

10. The method of claim 9, further comprising:
generating the standardized RFID event by an edge server;
communicating, by the edge server, the standardized RFID event to a cloud service; and
converting, by the cloud service, the one or more available sources of the location data into a standard spatial coordinate system.

11. The method of claim 10, wherein:
the standard spatial coordinate system comprises world geodetic system (WGS) 84;
the first RFID sensor and the second RFID sensor are provided by one device; and
the wireless communication protocol comprises at least one of ultrawide band (UWB) and Bluetooth low energy (BLE).

12. The method of claim 9, further comprising parsing the RFID event that comprises a lightweight computer data interchange format for substrings that correspond to the RFID, the location of the particular RFID tag, and identifier for a corresponding RFID sensor.

13. The method of claim 9, further comprising:
storing, in an asset database, one or more records that correspond respectively to an asset; an RFID assigned to the asset; and a reported location for the asset;
storing, in a historian, one or more standardized events from one or more controllers;
storing, in a sensor location database, one or more records that correspond respectively to a particular RFID sensor and the respective zone of the particular RFID sensor;
storing, in a zone database, one or more records that correspond respectively to each zone and the respective set of standardized spatial coordinates for the zone; and
associating the RFID and the location with a tracked asset by an asset management system that is communicatively coupled to the asset database, the historian, the sensor location database, and the zone database.

14. The method of claim 13, wherein associating the RFID and the location with the tracked asset further comprises:
identifying a particular zone as having a hazardous condition to humans;
identifying one or more RFIDs within the particular zone; and
generating a notification to one or more of an automated control system and a user interface device in response to determining that at least one of the one or more RFIDs with the particular zone is associated with an asset that is human.

15. The method of claim 13, further comprising:
receiving, via an input device, a user input for a query of one or more selected assets;
determining, via the asset management system, respective locations for the one or more selected assets; and
presenting, via an output device, a map of the respective locations.

16. Computer readable storage media comprising computer-executable instructions that, when executed by a processor, cause the processor to perform the following operations:
receiving, by a first radio frequency (RF) location sensor of one or more RFID sensors, a first radio frequency identification (RFID) event from an RFID tag in response to RFID interrogation in a first zone;
receiving, by a second RFID sensor of the one or more RFID sensors, a second RFID event communicated within a second zone using a wireless communication protocol;
for each RFID event, determining an RFID for a corresponding particular RFID tag of one of a passive RFID tag and an active RFID tag;
determining one or more available sources of location data for the particular RFID tag selected from a group comprising: location data included in the RFID data; signal strength and direction data detected by a corresponding RFID sensor; and information indicating a zone sensed by a corresponding RFID sensor;
generating a standardized RFID event including the one or more available sources of location data; and
based at least on the standardized RFID event associating the RFID and the one or more available sources of location data with a tracked asset.

17. The computer readable storage media of claim 16, wherein the computer-executable instructions further cause the processor to perform the following operations:
generating the standardized RFID event by an edge server;
communicating, by the edge server, the standardized RFID event to a cloud service; and
converting, by the cloud service, the one or more available sources of the location data into a standard spatial coordinate system.

18. The computer readable storage media of claim 16, wherein the computer-executable instructions further cause the processor to parse the RFID event that comprises a lightweight computer data interchange format for substrings that correspond to the RFID, the location of the particular RFID tag, and an identifier for a corresponding RFID sensor.

19. The computer readable storage media of claim 16, wherein the computer-executable instructions further cause the processor to perform the following operations:
storing, in an asset database, one or more records that correspond respectively to an asset; an RFID assigned to the asset; and a reported location for the asset;
storing, in a historian, one or more standardized events from one or more controllers;
storing, in a sensor location database, one or more records that correspond respectively to a particular RFID sensor and the respective zone of the particular RFID sensor;
storing, in a zone database, one or more records that correspond respectively to each zone and the respective set of standardized spatial coordinates for the zone; and
associating the RFID and the location with a tracked asset by the asset management system that is communicatively coupled to the asset database, the historian, the sensor location database, and the zone database.

20. The computer readable storage media of claim 19, wherein the computer-executable instructions further cause the processor to provide the functionality of associating the RFID and the location with the tracked asset by:
identifying a particular zone as having a hazardous condition to humans;
identifying one or more RFIDs within the particular zone; and
generating a notification to one or more of an automated control system and a user interface device in response to determining that at least one of the one or more RFIDs with the particular zone is associated with an asset that is human.
